(19) United States
(12) Patent Application Publication
(10) Pub. No.: US 2026/0238252 A1
(43) Pub. Date: Aug. 13, 2026

(54) SWITCHING TIME DETERMINATION

(71) Applicant: Nokia Technologies Oy, Espoo (FI)

(72) Inventors: Tanumay MANNA, Bangalore (IN); Rafael CAUDURO DIAS DE PAIVA, Cambridge (GB); Riikka Karoliina DIMNIK, Espoo (FI); Bent Henneberg RYSGAARD, Aalborg (DK)

(21) Appl. No.: 19/468,270

(22) Filed: Feb. 3, 2026

(30) Foreign Application Priority Data
Feb. 7, 2025 (IN) 202541010608

(51) Int. Cl. H04B 1/44; H04B 1/00

(52) U.S. Cl. CPC H04B 1/44; H04B 1/006

(57) ABSTRACT

Example embodiments of the present disclosure are directed to switching time estimation. A method comprises determining a first switching time for the first apparatus to switch from reception on a first carrier to reception on a second carrier based on a first set of time parameters associated with frequency switching; determining a second switching time for the first apparatus to switch from reception on the second carrier to reception on the first carrier based on a second set of time parameters associated with frequency switching; and performing reception on the first and second carriers based on the first and second switching times.

### CROSS-REFERENCE TO RELATED APPLICATION

This application claims priority from, and the benefit of, India Patent Application No. 202541010608, filed Feb. 7, 2025, the contents of which are hereby incorporated by reference in their entirety.

### FIELD

Various example embodiments of the present disclosure generally relate to the field of telecommunication and in particular, to switching time determination.

### BACKGROUND

Low-band (LB) carriers generally refer to electromagnetic waves with relatively low frequencies that are used to carry communication signals. LB carriers have long wavelengths and low propagation losses, enabling signals to travel over long distances. This gives them an advantage in long-distance communication, such as in rural areas. Additionally, LB carriers can penetrate buildings relatively well, making them suitable for scenarios where signals need to pass through obstacles, such as indoor communication in urban areas.

### SUMMARY

In a first aspect of the present disclosure, there is provided a first apparatus. The first apparatus comprises at least one processor; and at least one memory storing instructions that, when executed by the at least one processor, cause the first apparatus at least to: determine a first switching time for the first apparatus to switch from reception on a first carrier to reception on a second carrier based on a first set of time parameters associated with frequency switching; determine a second switching time for the first apparatus to switch from reception on the second carrier to reception on the first carrier based on a second set of time parameters associated with frequency switching; and perform reception on the first and second carriers based on the first and second switching times.

In a second aspect of the present disclosure, there is provided a second apparatus. The second apparatus comprises at least one processor; and at least one memory storing instructions that, when executed by the at least one processor, cause the first apparatus at least to: receive, from a first apparatus, time information associated with carrier switching at the first apparatus; determine, based on the received time information, a first switching time for switching from reception on a first carrier to reception on a second carrier and a second switching time for switching from reception on the second carrier to reception on the first carrier; and perform transmission on the first and second carriers based on the first and second switching times.

In a third aspect of the present disclosure, there is provided a method. The method comprises: determining a first switching time for the first apparatus to switch from reception on a first carrier to reception on a second carrier based on a first set of time parameters associated with frequency switching; determining a second switching time for the first apparatus to switch from reception on the second carrier to reception on the first carrier based on a second set of time parameters associated with frequency switching; and performing reception on the first and second carriers based on the first and second switching times.

In a fourth aspect of the present disclosure, there is provided a method. The method comprises: receiving, from a first apparatus, time information associated with carrier switching at the first apparatus; determining, based on the received time information, a first switching time for switching from reception on a first carrier to reception on a second carrier and a second switching time for switching from reception on the second carrier to reception on the first carrier; and performing transmission on the first and second carriers based on the first and second switching times.

In a fifth aspect of the present disclosure, there is provided a first apparatus. The first apparatus comprises means for determining a first switching time for the first apparatus to switch from reception on a first carrier to reception on a second carrier based on a first set of time parameters associated with frequency switching; means for determining a second switching time for the first apparatus to switch from reception on the second carrier to reception on the first carrier based on a second set of time parameters associated with frequency switching; and means for performing reception on the first and second carriers based on the first and second switching times.

In a sixth aspect of the present disclosure, there is provided a second apparatus. The second apparatus comprises means for receiving, from a first apparatus, time information associated with carrier switching at the first apparatus; means for determining, based on the received time information, a first switching time for switching from reception on a first carrier to reception on a second carrier and a second switching time for switching from reception on the second carrier to reception on the first carrier; and means for performing transmission on the first and second carriers based on the first and second switching times.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIGS. 1A-1D illustrate schematic diagrams of the applications of different carriers based on different distances from the cell center;

FIG. 2 illustrates example cases of switching between carriers;

FIG. 3 illustrates schematic diagrams of carrier switching between the frequency division duplexing (FDD) and supplementary downlink (SDL) carriers;

FIG. 4 illustrates examples of band combinations suitable for low-low band carrier aggregation (CA);

FIG. 5 illustrates a schematic diagram of the switching times between the FDD and SDL carriers;

FIG. 6 illustrates an example communication environment in which example embodiments of the present disclosure can be implemented;

FIG. 7 illustrates a signaling flow for switching time determination according to some example embodiments of the present disclosure;

FIG. 8 illustrates a schematic diagram of the switching times between the FDD and SDL carriers according to some example embodiments of the present disclosure;

FIG. 9 illustrates an example signaling flow for carriers switching in accordance with some example embodiments of the present disclosure;

FIG. 10 illustrates a signaling flow for switching time determination according to some example embodiments of the present disclosure;

FIG. 11 illustrates an example signaling flow for carriers switching in accordance with some example embodiments of the present disclosure;

FIG. 12A illustrates a flowchart of a method implemented at the first apparatus in accordance with some example embodiments of the present disclosure;

FIG. 12B illustrates a flowchart of a method implemented at the second apparatus in accordance with some example embodiments of the present disclosure;

FIG. 13A illustrates a flowchart of a method implemented at the first apparatus in accordance with some example embodiments of the present disclosure;

FIG. 13B illustrates a flowchart of a method implemented at the second apparatus in accordance with some example embodiments of the present disclosure;

FIG. 14 illustrates a simplified block diagram of a device that is suitable for implementing example embodiments of the present disclosure; and

FIG. 15 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of a WAB node or an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

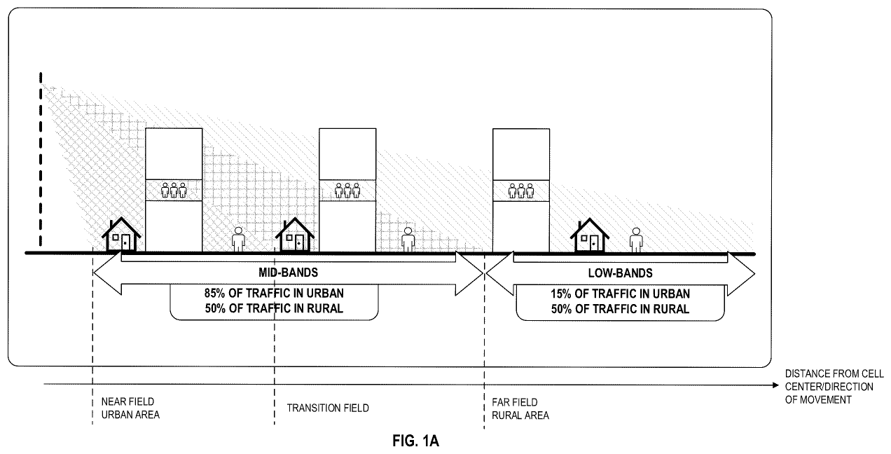

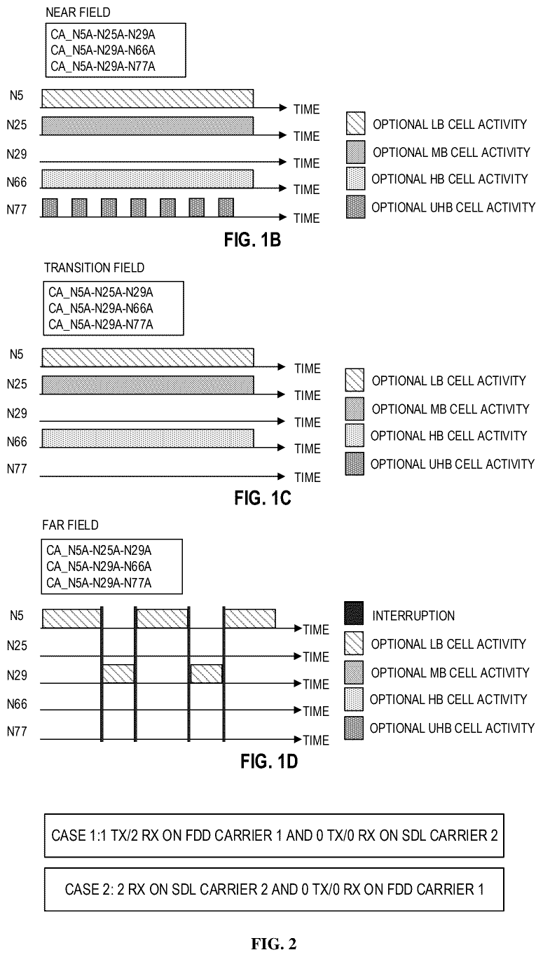

As mentioned above, LB carriers can propagate over longer distances and have a significant advantage in long-distance communication. Mid-band (MB) carriers, high-band (HB) carriers, and ultra-high band (UHB) carriers also have corresponding advantages in specific scenarios. FIGS. 1A-1D show schematic diagrams of the applications of different carriers based on different distances from the cell center. As shown in FIG. 1A, MB carriers are more useful near base stations, while LB carriers are more useful in areas far from base stations and for indoor communication in urban areas. As shown in FIG. 1B, in the near field, LB, MB and HB carriers have approximately the same level of activity, and UHB carrier is also active. As shown in FIG. 1B, in the transition field, LB, MB and HB carriers are all active as well. However, as shown in FIG. 1D, in the far field, almost only LB carriers are active.

The amount of mid-band spectrum held by operators is typically 10 to 20 times that of low-band spectrum. Therefore, in urban (indoor) and rural areas, LB carries a large volume of traffic, which leads to low-band congestion and severely degrades customer experience.

Low-low band carrier aggregation (CA) could be one way to solve this problem, but such a solution does not exist as original equipment manufacturers (OEMs) have challenges supporting it. Though low-band SDL bands reach most of the poor coverage areas, the absence of a mid-band with an uplink (UL) renders them useless.

To this end, a solution has been proposed. This solution enables the utilization of SDL through a low-low band CA approach with minimal impact on UE. As shown in FIG. 2, in this solution, the UE switches its configuration between two states of the radio frequency (RF) front-end, defined as case 1 and case 2. In case 1, one-way transmission (Tx) and two-way reception (Rx) operations are carried out on the FDD carrier, while there is no transmission and no reception on the SDL carrier. In case 2, two-way reception operations are carried out on the SDL carrier, and there is no transmission and no reception on the FDD carrier.

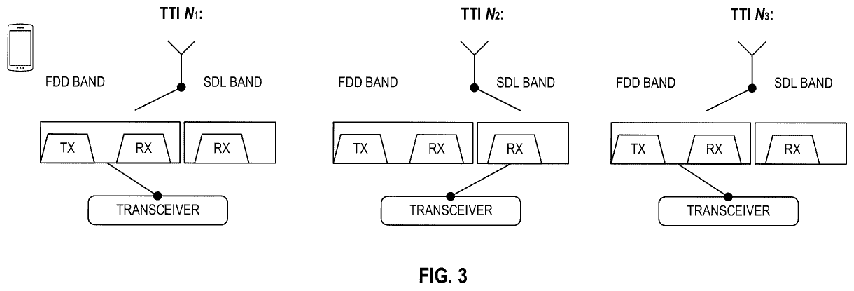

Switching between the two carriers will be further described below with reference to FIG. 3. As shown in FIG. 3, the transceiver of the UE switches between FDD band and SDL band in terms of transmission time interval (TTI). In TTI N1, the transceiver performs transmission and reception on the FDD band. In TTI N2, the transceiver switches to perform the reception on the SDL band. There is no UL transmission on the SDL band. After SDL scheduled reception interval is finished, the transceiver switches back to FDD duplexer to perform transmission and reception in TTI N3.

To implement this solution, some requirements are put forward for the UE. The UE needs to support inter-carrier scheduling. It monitors FDD downlink (DL) physical downlink control channel (PDCCH) downlink control information (DCI), which has both FDD and SDL scheduling. The UE needs to support TTI level switching. When the secondary cell (SCell) is scheduled, the UE needs to switch to the SCell filter. During the scheduled period, there is no simultaneous Tx/Rx between the primary cell (PCell) and the SCell.

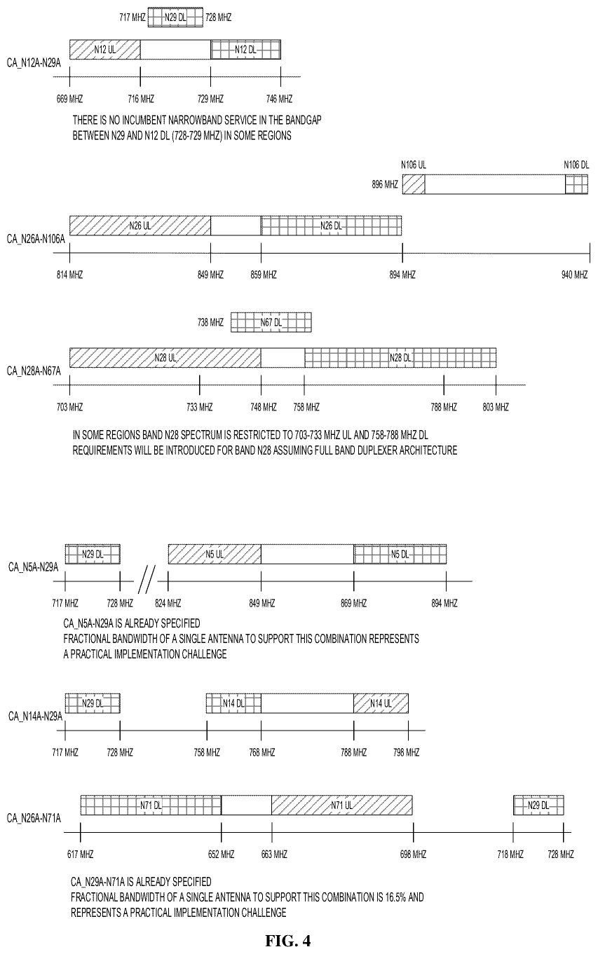

FIG. 4 illustrates some band combinations suitable for low-low band CA. For CA_n12A-n29A, it is noted that there is no incumbent narrowband service in the bandgap between n29 and n12 DL (728-729 MHz) in some regions. For CA_n28A-n67A, in some regions, band n28 spectrum is restricted to 703-733 MHz UL and 758-788 MHz DL. And requirements will be introduced for band n28, assuming full band duplexer architecture. CA_n5A-n29A is already specified. Fractional bandwidth of a single antenna to support this combination represents a practical implementation challenge. CA_n29A-n71A is also specified. Fractional bandwidth of a single antenna to support this combination is 16.5% and represents a practical implementation challenge.

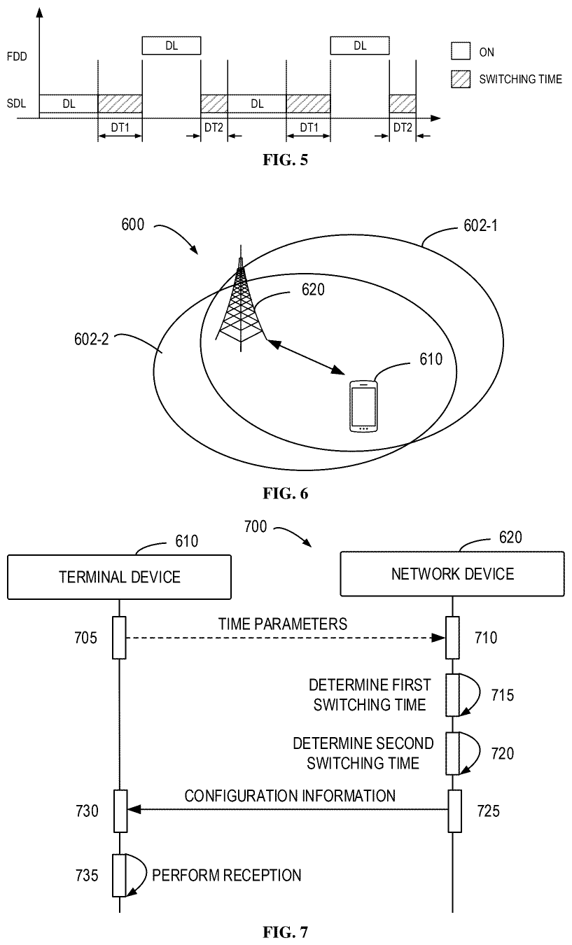

FIG. 5 illustrates a schematic diagram of the switching times between an FDD carrier and an SDL carrier. As shown in FIG. 5, dT2 refers to the time taken while switching from DL reception on FDD carrier to DL reception on SDL carrier, while dT1 denotes the time taken for switching back to FDD DL reception from SDL DL reception.

The TTI level switching for the low-low band CA needs to be accurate as it allows the network to prevent scheduling any DL transmission during the switching instances. In some solutions, the switching times are usually determined by looking up tables or referring to a predefined set of switching times. However, these solutions cannot meet the requirements for accuracy.

According to example embodiments of the present disclosure, there are proposed solutions to determine the switching times for the switching between reception on a first carrier and reception on a second carrier. The switching times are determined based on corresponding sets of time parameters associated with frequency switching.

With the solutions in the present disclosure, the switching times for carrier switching may be determined in a more reasonable and accurate manner, thus improving the accuracy of performing reception on different carriers.

FIG. 6 illustrates a schematic diagram of an example communication environment 600 in which example embodiments of the present disclosure can be implemented. In the communication environment 100, a plurality of communication devices, including a terminal device 610 and a network device 620, may communicate with each other.

In the example of FIG. 6, the terminal device 610 may be a UE and the network device 620 may be a base station serving the UE. The serving area of the network device 620 may be called cells. The cells may include a PCell 602-1 and a Scell 602-2. The network device 620 operates in a radio access network (RAN) and thus is also referred to as a RAN network device.

It is to be understood that the number of devices and their connections shown in FIG. 6 are only for the purpose of illustration without suggesting any limitation. The communication environment 600 may include any suitable number of devices configured to implement example embodiments of the present disclosure. Although not shown, it would be appreciated that one or more additional devices may be located in the PCell 602-1 and the SCell 602-2, and one or more additional cells may be deployed in the communication environment 600. It is noted that although illustrated as a network device, the network device 620 may be another device than a network device. Although illustrated as a terminal device, the terminal device 610 may be another device than a terminal device.

In the following, for the purpose of illustration, some example embodiments are described with a terminal device 610 operating as a UE and a network device 620 operating as a base station, e.g., gNB. However, in some example embodiments, operations described in connection with a terminal device may be implemented at a network device or other device, and operations described in connection with a network device may be implemented at a terminal device or other device.

In some example embodiments, a communication direction from the network device 620 to the terminal device 610 is referred to as a DL, while a communication direction from the terminal device 610 to the network device 620 is referred to as a UL. In DL, the network device 620 is a transmitting (TX) device (or a transmitter) and the terminal device 610 is a receiving (RX) device (or a receiver). In UL, the terminal device 610 is a TX device (or a transmitter) and the network device 620 is an RX device (or a receiver).

Communications in the communication environment 600 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Some example procedures are now described. FIG. 7 illustrates a signaling flow 700 for switching time determination according to some example embodiments of the present disclosure. As illustrated in FIG. 7, the signaling flow 700 may involve the terminal device 610 (as an example of the first apparatus) and the network device 620 (as an example of the second apparatus). For the purposes of discussion, the process 700 will be discussed with reference to FIG. 6.

The main concept of the present disclosure is to determine a first switching time and a second switching time by considering the possible operations that need to be performed by the terminal device 610 and the network device 620 during the carrier switching.

The first switching time is the time taken for the terminal device 610 to switch from reception on a first carrier to reception on a second carrier. The second switching time is the time taken for the terminal device 610 to switch from reception on the second carrier to reception on the first carrier. In some examples, the first switching time and the second switching time may be the same. In other examples, they may be different.

In some example embodiments, the first carrier may be an SDL carrier, and the second carrier may be an FDD carrier. The FDD carrier is the only one with UL in this case. Some example embodiments in the present disclosure may be illustrated by taking the SDL carrier and the FDD carrier as examples. However, it is to be understood that these embodiments may also be implemented on other LB carriers and even various suitable carriers.

As shown in FIG. 7, in some example embodiments, the terminal device 610 may transmit (705), to the network device 620, one or more time parameters associated with frequency switching at the terminal device 610. The network device 620 may receive (710) the one or more time parameters from the terminal device 610. The one or more time parameters may represent the time of possible operations that the terminal device 610 performs for carrier switching.

In some examples, the one or more time parameters may comprise a first retuning time and a second retuning time. The first retuning time is the time taken for retuning a receiver from a first frequency of the first carrier to a second frequency of the second carrier. The second retuning time is the time taken for retuning the receiver from the second frequency of the second carrier to the first frequency of the first carrier. The retuning times refer to the time involved in turning on a frequency conversion component (e.g., a local oscillator (LO)) of the receiver and/or retuning the frequency conversion component from the frequency of the first carrier to the frequency of the second carrier.

In examples where the same frequency conversion component is used for the two carriers, the first retuning time and the second retuning time may be the time for the frequency conversion component to tune its operating frequency, and the first retuning time and the second retuning time may be the same. In examples where different frequency conversion components are used for the two carriers, these two retuning times may be time for a receiver of the terminal device 610 to switch from a frequency conversion component to another frequency conversion component. In this case, the two retuning times may be the same or different.

In some examples, the one or more time parameters may comprise an activation time for activating a transmitter for a transmission from the terminal device 610 to the network device 620. For example, when the terminal device 610 switches from the SDL carrier to the FDD carrier, it may take the activation time to activate its transmitter for uplink transmissions.

Alternatively, or in addition, in some example embodiments, the terminal device 610 may also transmit the minimum switching time calculated based on these parameters.

In some examples, the one or more time parameters may comprise a first reference time and a second reference time. The first reference time is the time required by the terminal device 610 to switch from the first carrier to the second carrier. The second reference time is the time required by the terminal device 610 to switch from the second carrier to the first carrier. The first and second reference times may be the corresponding minimum switching times. The minimum switching times refer to the minimum time required for the terminal device 610 to perform carrier switching. For example, the minimum switching times may be calculated by the terminal device 610 based on the time taken for the necessary operations of carrier switching.

In some example embodiments, the terminal device 610 may determine the first reference time based on the first retuning time and the activation time. The second reference time may be determined based on the second retuning time. For example, the first reference time may be the sum of the first retuning time and the activation time. The second reference time may be equal to the second retuning time.

Now continue with FIG. 7. The network device 620 determines (715) the first switching time based on a first set of time parameters, and determines (720) the second switching time based on a second set of time parameters. In some example embodiments, the first set of time parameters may comprise at least one of the received one or more time parameters. The second set of time parameters may comprise at least one of the received one or more time parameters.

In an example, the first set of time parameters may comprise the first retuning time, the activation time, and a timing advance indicated by the network device 620 to the terminal device 610. The second set of time may comprise the second retuning time. Due to the delay of wireless signals during transmission, the terminal device 610 needs to transmit data in advance by a certain amount of time according to the indication from the network device 620. This is to ensure that the uplink data can accurately arrive within the time window expected by the network device 620. Thus, the timing advance refers to the amount of time that the network device 620 indicates the terminal device 610 to transmit signals in advance.

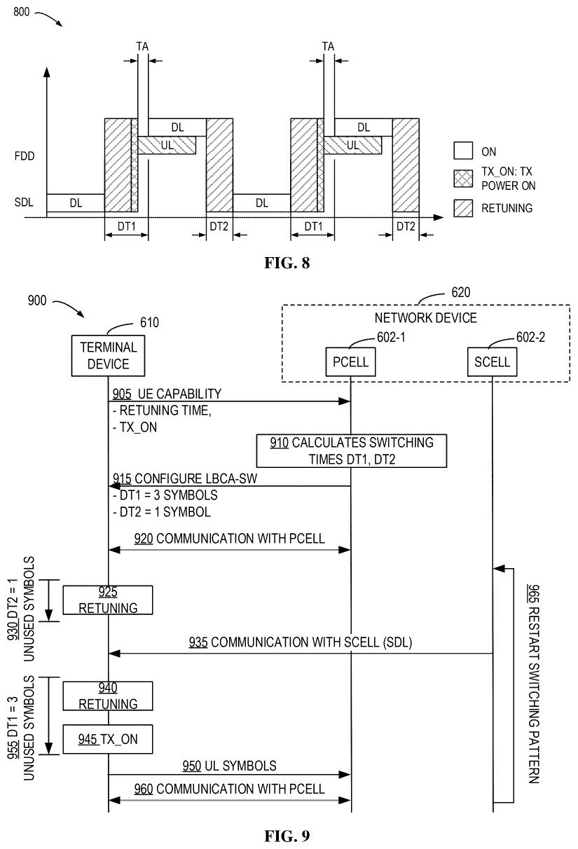

Now, refer to FIG. 8 to introduce an example of the first and second switching times. As shown in FIG. 8, the time dT1 represents the time required for switching from the SDL carrier to the FDD carrier, while the time dT2 is the time for switching from the FDD carrier to the SDL carrier. The FDD carrier is the only carrier with UL.

Regarding the retuning time, in one architecture option, it refers to the time involved in turning on the RF receiver chain LO and/or retuning the LO from the SDL frequency to the FDD frequency. Therefore, the first switching time dT1 and the switching time dT2 may be determined as:

$$dT 1 \geq returning time + TX\_ON + TA$$

$$dT 2 \geq returning time$$

where TX_ON is the time taken by the terminal device 610 to activate its transmitter for uplink transmissions. TA represents the timing advance before the start of the corresponding downlink frame at the terminal device 610.

In examples where the terminal device 610 transmits the first reference time and the second reference time to the network device 620, the first set of time parameters may include the first reference time and the timing advance. The second set of time parameters may include the second reference time.

The determination methods of the first and second switching times introduced above are merely exemplary rather than restrictive. Other possible calculation methods are also feasible.

Continue with the FIG. 7. The network device 620 transmits (725), to the terminal device 610, configuration information comprising the first switching time and the second switching time. The terminal device 610 receives (730) the switching times and performs (735) reception on the first and second carriers based on the first and second switching times.

In some example embodiments, the terminal device 610 may switch from reception on the first carrier to reception on the second carrier by performing the following operations. The terminal device 610 may retune a receiver from a first frequency of the first carrier to a second frequency of the second carrier. It may activate a transmitter for the UL transmission, and it may perform a transmission to the network device 620 based on the timing advance.

In some example embodiments, the terminal device 610 may switch from reception on the second carrier to reception on the first carrier by retuning the receiver from the second frequency of the second carrier to the first frequency of the first carrier.

FIG. 9 illustrates an example signaling flow 900 for carriers switching in accordance with some example embodiments of the present disclosure. The signaling flow 900 may be considered as an example of the signaling flow 700 of FIG. 7. For the purpose of illustration, the signaling flow 900 will be described with respect to FIG. 6. The signaling flow 900 involves the terminal device 610, the network device 620, the PCell 602-1 and the SCell 602-2. In this example, the PCell 602-1 communicates with the terminal device 610 via the FDD carrier, and SCell 602-2 communicates with the terminal device 610 via the SDL carrier.

As shown in FIG. 9, at 905, the terminal device 610 informs the network device 620 about the time parameters such as the retuning time and TX_ON. In some examples, these time parameters may be included in the capability information of the terminal device 610. At 910, the network device 620 calculates the switching times dT1 and dT2. The calculation methods may include, but are not limited to, the methods mentioned above. At 915, the network device 620 configures the switching pattern of low-low CA with asymmetric switching times dT1 (3 symbols) and dT2 (1 symbol). The first switching time dT1 and the second switching time dT2 may be configured as part of the carrier switching configuration.

Then, at 920, the terminal device 610 communicates with the network device 620 on the FDD carrier as per network configuration. At 925, the terminal device 610 switches to the SDL carrier by retuning its LOs. At 930, the terminal device 610 completes switching within the configured second switching time dT2. After completion of switching, at 935, the network device 620 schedules DL data to the terminal device 610 on the SDL carrier.

At 940 and 945, the terminal device 610 switches to FDD carrier by retuning its LOs, and activating its transmitter for UL transmissions. At 950, the terminal device 610 transmits UL symbols by applying the timing advance before the start of the corresponding DL frame. At 955, the terminal device 610 completes switching within the configured first switching time dT1, and is ready to receive DL frame from the network device 620. At 960, after completion of switching, the network device 620 schedules DL data to the terminal device 610 on the FDD carrier.

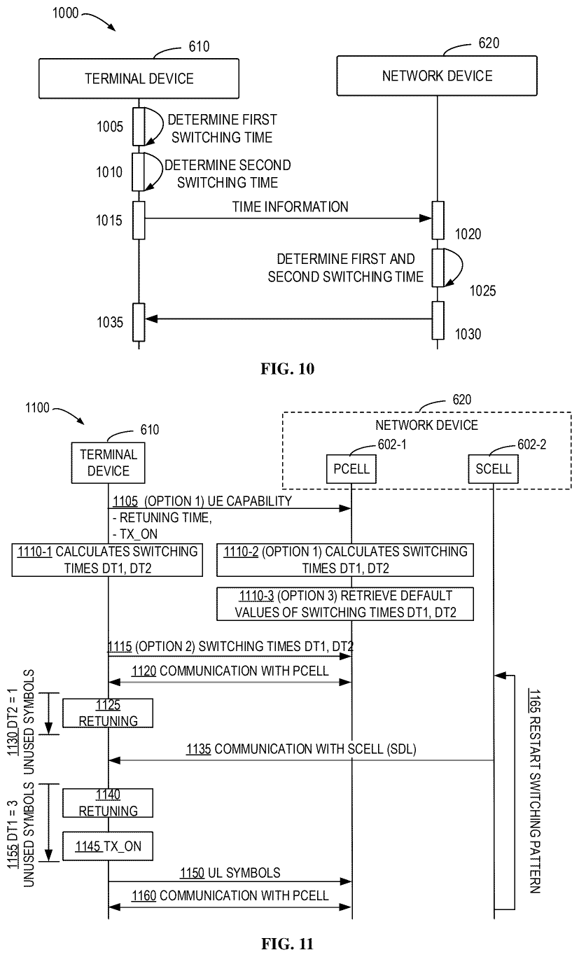

The above has introduced the example embodiments in which the network device 620 determines the switching times. The solution in which the terminal device 610 calculates the switching times is also feasible. The following will introduce this solution with reference to FIG. 10.

FIG. 10 illustrates a signaling flow 1000 for switching time determination according to some example embodiments of the present disclosure. As illustrated in FIG. 10, the signaling flow 1000 may involve the terminal device 610 (as an example of the first apparatus) and the network device 620 (as an example of the second apparatus). For the purposes of discussion, the process 1000 will be discussed with reference to FIG. 6.

The parameters involved in the following may all refer to those in the example embodiments above.

As shown in FIG. 10, the terminal device 610 determines (1005) the first switching time based on the first set of time parameters associated with frequency switching and determines (1010) the second switching time based on the second set of time parameters associated with frequency switching.

As described above, the first set of time parameters may comprise the first retuning time, the activation time and the timing advance. In some example embodiments, the terminal device 610 may receive configuration information from the network device 620. The timing advance may be comprised in the received configuration information. The second set of time parameters may comprise the second retuning time.

In order to maintain communication with the network device 620 when switching between different carriers, the terminal device 610 may transmit (1015), to the network device 620, time information associated with carrier switching.

In some example embodiments, the terminal device 610 may directly transmit the first and second switching times as the time information to the network device 620.

Alternatively, or in addition, in some example embodiments, the time information may comprise the one or more time parameters associated with frequency switching at the terminal device 610. The one or more time parameters may be comprised in at least one of the first or second set of time parameters.

Continue with FIG. 10. The network device 620 receives (1020) the time information and determine (1025) the first and second switching times based on the time information. Then, the network device 620 performs (1030) transmission on the first and second carriers based on the first and second switching times.

In the examples where the terminal device 610 directly transmits the first and second switching times, the network device 620 does not need to calculate the first and second switching times on its own.

In some example embodiments, the first switching time may be selected from a first set of switching times, and the second switching time may be selected from a second set of switching times. Sets of switching times may be predefined both at the terminal device 610 and the network device 620. If the network device 620 does not receive the signaling in which the terminal device 610 transmits the first and second switching times, the network device 620 may retrieve the default values of the first and second switching times from this predefined set.

In the examples where the terminal device 610 transmits the time parameters associated with frequency switching, the network device 620 may determine the first switching time based on a first set of time parameters comprising at least one of the one or more time parameters and determine the second switching time based on a second set of time parameters comprising at least one of the one or more time parameters. For example, the first set of time parameters may comprise the first retuning time, the activation time and the timing advance. The second set of time parameters may comprise the second retuning time. The network device 620 may calculate the first and second switching times based on the common understanding with the terminal device 610.

As shown in FIG. 10, the network device 620 may perform (1030) transmission and the terminal device 610 may perform (1035) reception on the first and second carriers based on the first and second switching times.

FIG. 11 illustrates an example signaling flow 1100 for carriers switching in accordance with some example embodiments of the present disclosure. The signaling flow 1100 may be considered as an example of the signaling flow 1000 of FIG. 10. For the purpose of illustration, the signaling flow 1100 will be described with respect to FIG. 6. The signaling flow 1100 involves the terminal device 610, the network device 620, the PCell 602-1 and the SCell 602-2. In this example, the PCell 602-1 communicates with the terminal device 610 via the FDD carrier, and SCell 602-2 communicates with the terminal device 610 via the SDL carrier.

The signaling flow 1100 includes two options for the network device 620 to obtain the first and second switching times. In option 1, the terminal device 610 directly transmits the first and second switching times to the network device 620. In option 2, the terminal device 610 transmits one or more time parameters to the network device 620. The network device 620 calculates the first and second switching times on its own based on the received time parameters and the common understanding with the terminal device 610.

In some example embodiments, the network device 620 may have option 3 to obtain the first and second switching times. In option 3, the first switching time may be selected from a first set of switching times, and the second switching time may be selected from a second set of switching times. The first and second sets of switching times may be predefined both at the terminal device 610 and the network device 620. For example, if the network device 620 neither receives the time parameters nor receives the first and second switching times, it may retrieve the default values of the first and second switching times from the predefined sets, respectively.

As shown in FIG. 11, in option 1, the terminal device 610 informs the network device 620 about the time parameters such as the retuning time and TX_ON at 1105. And the network device 620 calculates the switching times dT1 and dT2 based on the received time parameters at 1110-2.

At 1110-1, the terminal device 610 calculates the switching times dT1 and dT2.

In option 3, the terminal device 610 retrieves the default values of the first and second switching times from the predefined sets at 1110-3. For example, if the network device 620 neither receives the time parameters nor receives the first and second switching times, it may retrieve the default values of the first and second switching times from the predefined sets, respectively. In option 2, the terminal device 610 transmits the first and second switching times to the network device 620 at 1115.

Then, at 1120, the terminal device 610 communicates with the network device 620 on the FDD carrier. At 1125, the terminal device 610 switches to the SDL carrier by retuning its LOs. At 1130, the terminal device 610 completes switching within the second switching time dT2. After completion of switching, at 1135, the network device 620 schedules DL data to the terminal device 610 on the SDL carrier.

At 1140 and 1145, the terminal device 610 switches to FDD carrier by retuning its LOs, and activating its transmitter for UL transmissions. At 1150, the terminal device 610 transmits UL symbols by applying the timing advance before the start of the corresponding DL frame. At 1155, the terminal device 610 completes switching within the configured first switching time dT1, and is ready to receive DL frame from the network device 620. At 1160, after completion of switching, the network device 620 schedules DL data to the terminal device 610 on the FDD carrier.

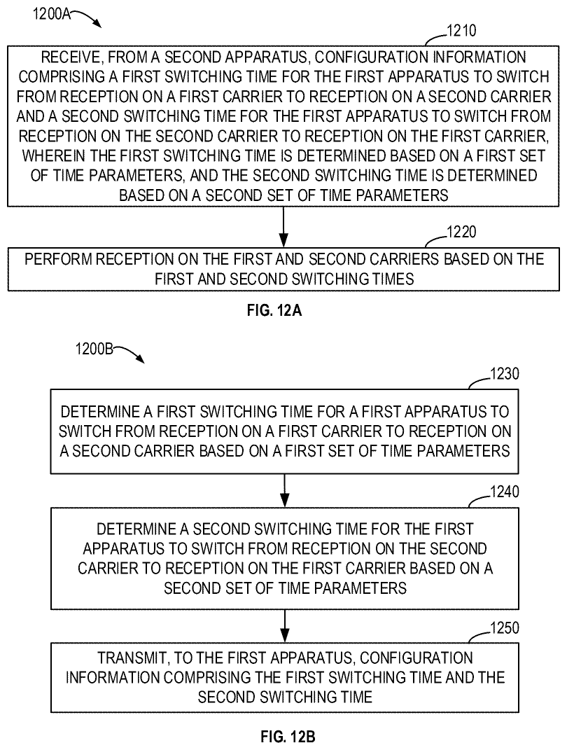

FIG. 12A shows a flowchart of an example method 1200A implemented at a first apparatus in accordance with some example embodiments of the present disclosure. For the purpose of discussion, the method 1200A will be described from the perspective of the terminal device 610 in FIG. 6.

At block 1210, the terminal device 610 receives, from a second apparatus, configuration information comprising a first switching time for the first apparatus to switch from reception on a first carrier to reception on a second carrier and a second switching time for the first apparatus to switch from reception on the second carrier to reception on the first carrier, wherein the first switching time is determined based on a first set of time parameters, and the second switching time is determined based on a second set of time parameters.

At block 1220, the terminal device 610 performs reception on the first and second carriers based on the first and second switching times.

In some example embodiments, the method 1200A may further comprise: transmitting, to the second apparatus, one or more time parameters associated with frequency switching at the first apparatus, and wherein the first set of time parameters comprises at least one of the one or more time parameters, and the second set of time parameters comprises at least one of the one or more time parameters.

In some example embodiments, the one or more time parameters may comprise at least one of: a first retuning time for retuning a receiver from a first frequency of the first carrier to a second frequency of the second carrier, a second retuning time for retuning the receiver from the second frequency of the second carrier to the first frequency of the first carrier, or an activation time for activating a transmitter for a transmission from the first apparatus to the second apparatus.

In some example embodiments, the first carrier is configured for a transmission from the second apparatus to the first apparatus, and the second carrier is configured for a transmission from the first apparatus to the second apparatus and a transmission from the second apparatus to the first apparatus, the first set of time parameters may comprise: the first retuning time, the activation time, and a timing advance indicated by the second apparatus to the first apparatus, and the second set of time may comprise the second retuning time.

In some example embodiments, the one or more time parameters may comprise at least one of: a first reference time required by the first apparatus to switch from the first carrier to the second carrier, or a second reference time required by the first apparatus to switch from the second carrier to the first carrier.

In some example embodiments, the first carrier is configured for a transmission from the second apparatus to the first apparatus, and the second carrier is configured for a transmission from the first apparatus to the second apparatus and a transmission from the second apparatus to the first apparatus, and the first apparatus may be caused to determine the first reference time based on a first retuning time and an activation time, the first retuning time is for retuning a receiver from a first frequency of the first carrier to a second frequency of the second carrier, the activation time is for activating a transmitter for a transmission from the first apparatus to the second apparatus; and determine the second reference time based on a second retuning time for retuning the receiver from the second frequency of the second carrier to the first frequency of the first carrier.

In some example embodiments, the first carrier is configured for a transmission from the second apparatus to the first apparatus, and the second carrier is configured for a transmission from the first apparatus to the second apparatus and a transmission from the second apparatus to the first apparatus, the first set of time parameters may comprise the first reference time and a timing advance indicated by the second apparatus to the first apparatus, and the second set of time may comprise the second reference time.

In some example embodiments, the method 1200A may further comprise: switching from reception on the first carrier to reception on the second carrier by: retuning a receiver from a first frequency of the first carrier to a second frequency of the second carrier; activating a transmitter for a transmission from the first apparatus to the second apparatus; and performing a transmission to the second apparatus based on a timing advance indicated by the second apparatus to the first apparatus.

In some example embodiments, the method 1200A may further comprise: switching from reception on the second carrier to reception on the first carrier by: retuning a receiver from a second frequency of the second carrier to a first frequency of the first carrier.

In some example embodiments, the first carrier may be a supplementary downlink, SDL, carrier and the second carrier may be a frequency division duplexing, FDD, carrier.

FIG. 12B shows a flowchart of an example method 1200B implemented at a second apparatus in accordance with some example embodiments of the present disclosure. For the purpose of discussion, the method 1200B will be described from the perspective of the network device 620 in FIG. 6.

At block 1230, the network device 620 determines a first switching time for a first apparatus to switch from reception on a first carrier to reception on a second carrier based on a first set of time parameters.

At block 1240, the network device 620 determines a second switching time for the first apparatus to switch from reception on the second carrier to reception on the first carrier based on a second set of time parameters.

At block 1250, the network device 620 transmits, to the first apparatus, configuration information comprising the first switching time and the second switching time.

In some example embodiments, the method 1200B may further comprise: receiving, from the first apparatus, one or more time parameters associated with frequency switching at the first apparatus, and wherein the first set of time parameters comprises at least one of the one or more time parameters, and the second set of time parameters comprises at least one of the one or more time parameters.

In some example embodiments, the one or more time parameters may comprise at least one of: a first retuning time for retuning a receiver at the first apparatus from a first frequency of the first carrier to a second frequency of the second carrier, a second retuning time for retuning the receiver from the second frequency of the second carrier to the first frequency of the first carrier, or an activation time for activating a transmitter at the first apparatus for a transmission from the first apparatus to the second apparatus.

In some example embodiments, the first carrier is configured for a transmission from the second apparatus to the first apparatus, and the second carrier is configured for a transmission from the first apparatus to the second apparatus and a transmission from the second apparatus to the first apparatus, the first set of time parameters may comprise: the first retuning time, the activation time, and a timing advance indicated by the second apparatus to the first apparatus, and the second set of time comprises the second retuning time.

In some example embodiments, the one or more time parameters may comprise at least one of: a first reference time required by the first apparatus to switch from the first carrier to the second carrier, or a second reference time required by the first apparatus to switch from the second carrier to the first carrier.

In some example embodiments, the first carrier is configured for a transmission from the second apparatus to the first apparatus, and the second carrier is configured for a transmission from the first apparatus to the second apparatus and a transmission from the second apparatus to the first apparatus, the first reference time may be determined based on a first retuning time and an activation time, the first retuning time is for retuning a receiver from a first frequency of the first carrier to a second frequency of the second carrier, the activation time is for activating a transmitter for a transmission from the first apparatus to the second apparatus; and the second reference time may be determined based on a second retuning time for retuning the receiver from the second frequency of the second carrier to the first frequency of the first carrier.

In some example embodiments, the first carrier is configured for a transmission from the second apparatus to the first apparatus, and the second carrier is configured for a transmission from the first apparatus to the second apparatus and a transmission from the second apparatus to the first apparatus, the first set of time parameters may comprise the first reference time and a timing advance indicated by the second apparatus to the first apparatus, and the second set of time may comprise the second reference time.

In some example embodiments, the first carrier may be a supplementary downlink, SDL, carrier and the second carrier may be a frequency division duplexing, FDD, carrier.

In some example embodiments, a first apparatus capable of performing any of the method 1200A (for example, the terminal device 610 in FIG. 6) may comprise means for performing the respective operations of the method 1200A. The means may be implemented in any suitable form. For example, the means may be implemented in a circuitry or software module. The first apparatus may be implemented as or included in the terminal device 610 in FIG. 6.

In some example embodiments, the first apparatus comprises means for receiving, from a second apparatus, configuration information comprising a first switching time for the first apparatus to switch from reception on a first carrier to reception on a second carrier and a second switching time for the first apparatus to switch from reception on the second carrier to reception on the first carrier, wherein the first switching time is determined based on a first set of time parameters, and the second switching time is determined based on a second set of time parameters; and means for performing reception on the first and second carriers based on the first and second switching times.

In some example embodiments, the first apparatus may further comprise: means for transmitting, to the second apparatus, one or more time parameters associated with frequency switching at the first apparatus, means for and wherein the first set of time parameters comprises at least one of the one or more time parameters, and the second set of time parameters comprises at least one of the one or more time parameters.

In some example embodiments, the one or more time parameters may comprise at least one of: a first retuning time for retuning a receiver from a first frequency of the first carrier to a second frequency of the second carrier, a second retuning time for retuning the receiver from the second frequency of the second carrier to the first frequency of the first carrier, or an activation time for activating a transmitter for a transmission from the first apparatus to the second apparatus.

In some example embodiments, the first carrier is configured for a transmission from the second apparatus to the first apparatus, and the second carrier is configured for a transmission from the first apparatus to the second apparatus and a transmission from the second apparatus to the first apparatus, the first set of time parameters may comprise: the first retuning time, the activation time, and a timing advance indicated by the second apparatus to the first apparatus, and the second set of time may comprise the second retuning time.

In some example embodiments, the one or more time parameters may comprise at least one of: a first reference time required by the first apparatus to switch from the first carrier to the second carrier, or a second reference time required by the first apparatus to switch from the second carrier to the first carrier.

In some example embodiments, the first carrier is configured for a transmission from the second apparatus to the first apparatus, and the second carrier is configured for a transmission from the first apparatus to the second apparatus and a transmission from the second apparatus to the first apparatus, and the first apparatus may be caused to determine the first reference time based on a first retuning time and an activation time, the first retuning time is for retuning a receiver from a first frequency of the first carrier to a second frequency of the second carrier, the activation time is for activating a transmitter for a transmission from the first apparatus to the second apparatus; and determine the second reference time based on a second retuning time for retuning the receiver from the second frequency of the second carrier to the first frequency of the first carrier.

In some example embodiments, the first carrier is configured for a transmission from the second apparatus to the first apparatus, and the second carrier is configured for a transmission from the first apparatus to the second apparatus and a transmission from the second apparatus to the first apparatus, the first set of time parameters may comprise the first reference time and a timing advance indicated by the second apparatus to the first apparatus, and the second set of time may comprise the second reference time.

In some example embodiments, the first apparatus may further comprise: means for switching from reception on the first carrier to reception on the second carrier by: means for retuning a receiver from a first frequency of the first carrier to a second frequency of the second carrier; means for activating a transmitter for a transmission from the first apparatus to the second apparatus; and means for performing a transmission to the second apparatus based on a timing advance indicated by the second apparatus to the first apparatus.

In some example embodiments, the first apparatus may further comprise: means for switching from reception on the second carrier to reception on the first carrier by: means for retuning a receiver from a second frequency of the second carrier to a first frequency of the first carrier.

In some example embodiments, the first carrier may be a supplementary downlink, SDL, carrier and the second carrier may be a frequency division duplexing, FDD, carrier.

In some example embodiments, a second apparatus capable of performing any of the method 1200B (for example, the network device 620 in FIG. 6) may comprise means for performing the respective operations of the method 1200B. The means may be implemented in any suitable form. For example, the means may be implemented in a circuitry or software module. The second apparatus may be implemented as or included in the network device 620 in FIG. 6.

In some example embodiments, the second apparatus comprises means for determining a first switching time for a first apparatus to switch from reception on a first carrier to reception on a second carrier based on a first set of time parameters; means for determining a second switching time for the first apparatus to switch from reception on the second carrier to reception on the first carrier based on a second set of time parameters; and means for transmitting, to the first apparatus, configuration information comprising the first switching time and the second switching time.

In some example embodiments, the second apparatus may further comprise: means for receiving, from the first apparatus, one or more time parameters associated with frequency switching at the first apparatus, means for and wherein the first set of time parameters comprises at least one of the one or more time parameters, and the second set of time parameters comprises at least one of the one or more time parameters.

In some example embodiments, the one or more time parameters may comprise at least one of: a first retuning time for retuning a receiver at the first apparatus from a first frequency of the first carrier to a second frequency of the second carrier, a second retuning time for retuning the receiver from the second frequency of the second carrier to the first frequency of the first carrier, or an activation time for activating a transmitter at the first apparatus for a transmission from the first apparatus to the second apparatus.

In some example embodiments, the first carrier is configured for a transmission from the second apparatus to the first apparatus, and the second carrier is configured for a transmission from the first apparatus to the second apparatus and a transmission from the second apparatus to the first apparatus, the first set of time parameters may comprise: the first retuning time, the activation time, and a timing advance indicated by the second apparatus to the first apparatus, and the second set of time may comprise the second retuning time.

In some example embodiments, the one or more time parameters may comprise at least one of: a first reference time required by the first apparatus to switch from the first carrier to the second carrier, or a second reference time required by the first apparatus to switch from the second carrier to the first carrier.

In some example embodiments, the first carrier is configured for a transmission from the second apparatus to the first apparatus, and the second carrier is configured for a transmission from the first apparatus to the second apparatus and a transmission from the second apparatus to the first apparatus, the first reference time may be determined based on a first retuning time and an activation time, the first retuning time is for retuning a receiver from a first frequency of the first carrier to a second frequency of the second carrier, the activation time is for activating a transmitter for a transmission from the first apparatus to the second apparatus; and the second reference time may be determined based on a second retuning time for retuning the receiver from the second frequency of the second carrier to the first frequency of the first carrier.

In some example embodiments, the first carrier is configured for a transmission from the second apparatus to the first apparatus, and the second carrier is configured for a transmission from the first apparatus to the second apparatus and a transmission from the second apparatus to the first apparatus, the first set of time parameters may comprise the first reference time and a timing advance indicated by the second apparatus to the first apparatus, and the second set of time may comprise the second reference time.

In some example embodiments, the first carrier may be a supplementary downlink, SDL, carrier and the second carrier may be a frequency division duplexing, FDD, carrier.

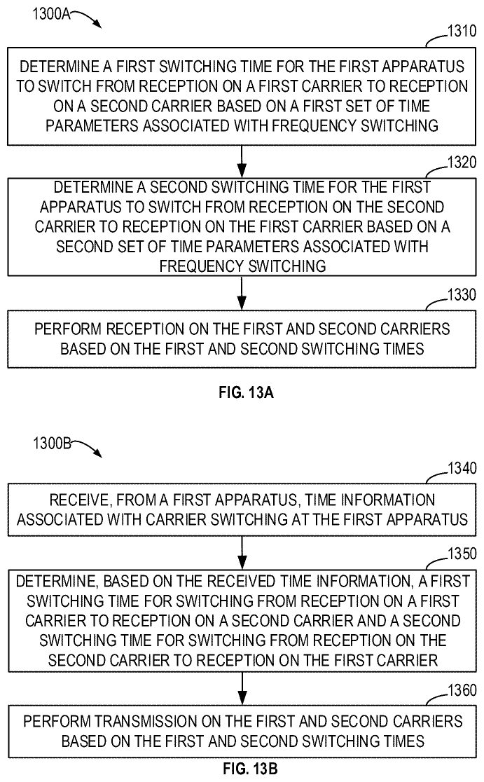

FIG. 13A shows a flowchart of an example method 1300A implemented at a first apparatus in accordance with some example embodiments of the present disclosure. For the purpose of discussion, the method 1300A will be described from the perspective of the terminal device 610 in FIG. 6.

At block 1310, the terminal device 610 determines a first switching time for the first apparatus to switch from reception on a first carrier to reception on a second carrier based on a first set of time parameters associated with frequency switching.

At block 1320, the terminal device 610 determines a second switching time for the first apparatus to switch from reception on the second carrier to reception on the first carrier based on a second set of time parameters associated with frequency switching.

At block 1330, the terminal device 610 performs reception on the first and second carriers based on the first and second switching times.

In some example embodiments, the first carrier is configured for a transmission from the second apparatus to the first apparatus, and the second carrier is configured for a transmission from the first apparatus to the second apparatus and a transmission from the second apparatus to the first apparatus, and the first set of time parameters may comprise: a first retuning time for retuning a receiver from a first frequency of the first carrier to a second frequency of the second carrier, an activation time for activating a transmitter for a transmission from the first apparatus to the second apparatus, and a timing advance indicated by the second apparatus to the first apparatus, and wherein the second set of time may comprise a second retuning time for retuning the receiver from the second frequency of the second carrier to the first frequency of the first carrier.

In some example embodiments, the method 1300A may further comprise: receiving, from the second apparatus, configuration information comprising the timing advance.

In some example embodiments, the method 1300A may further comprise: transmitting, to the second apparatus, time information associated with carrier switching at the first apparatus.

In some example embodiments, the time information may comprise the first and second switching times.

In some example embodiments, the first switching time may be selected from a first set of switching times, and the second switching time may be selected from a second set of switching times.

In some example embodiments, the time information may comprise one or more time parameters associated with frequency switching at the first apparatus, and the one or more time parameters are comprised in at least one of the first or second set of time parameters.

In some example embodiments, the one or more time parameters may comprise at least one of: a first retuning time for retuning a receiver from a first frequency of the first carrier to a second frequency of the second carrier, a second retuning time for retuning the receiver from the second frequency of the second carrier to the first frequency of the first carrier, or an activation time for activating a transmitter for a transmission from the first apparatus to the second apparatus.

In some example embodiments, the method 1300A may further comprise: switching from reception on the first carrier to reception on the second carrier by: retuning a receiver from a first frequency of the first carrier to a second frequency of the second carrier; activating a transmitter for a transmission from the first apparatus to the second apparatus; and performing a transmission to the second apparatus based on a timing advance indicated by the second apparatus to the first apparatus.

In some example embodiments, the method 1300A may further comprise: switching from reception on the second carrier to reception on the first carrier by: retuning a receiver from a second frequency of the second carrier to a first frequency of the first carrier.

In some example embodiments, the first carrier may be a supplementary downlink, SDL, carrier and the second carrier may be a frequency division duplexing, FDD, carrier.

FIG. 13B shows a flowchart of an example method 1300B implemented at a second apparatus in accordance with some example embodiments of the present disclosure. For the purpose of discussion, the method 1300B will be described from the perspective of the network device 620 in FIG. 6.

At block 1340, the network device 620 receives, from a first apparatus, time information associated with carrier switching at the first apparatus.

At block 1350, the network device 620 determines, based on the received time information, a first switching time for switching from reception on a first carrier to reception on a second carrier and a second switching time for switching from reception on the second carrier to reception on the first carrier.

At block 1360, the network device 620 performs transmission on the first and second carriers based on the first and second switching times.

In some example embodiments, the time information may comprise the first and second switching times.

In some example embodiments, the first switching time may be selected from a first set of switching times, and the second switching time may be selected from a second set of switching times. The first and second sets of switching times may be predefined both at the terminal device 610 and the network device 620. If the network device 620 does not receive the signaling in which the terminal device 610 transmits the first and second switching times, the network device 620 may retrieve the default values of the first and second switching times from these predefined sets, respectively.

In some example embodiments, the method 1300B may further comprise: determining the first switching time based on a first set of time parameters comprising at least one of the one or more time parameters; and determining the second switching time based on a second set of time parameters comprising at least one of the one or more time parameters.

In some example embodiments, the one or more time parameters may comprise at least one of: a first retuning time for retuning a receiver from a first frequency of the first carrier to a second frequency of the second carrier, a second retuning time for retuning the receiver from the second frequency of the second carrier to the first frequency of the first carrier, or an activation time for activating a transmitter for a transmission from the first apparatus to the second apparatus.

In some example embodiments, the first carrier is configured for a transmission from the second apparatus to the first apparatus, and the second carrier is configured for a transmission from the first apparatus to the second apparatus and a transmission from the second apparatus to the first apparatus, the first set of time parameters may comprise: the first retuning time, the activation time, and a timing advance indicated by the second apparatus to the first apparatus, and the second set of time may comprise the second retuning time.

In some example embodiments, the first carrier may be a supplementary downlink, SDL, carrier and the second carrier may be a frequency division duplexing, FDD, carrier.

In some example embodiments, a first apparatus capable of performing any of the method 1300A (for example, the terminal device 610 in FIG. 6) may comprise means for performing the respective operations of the method 1300A. The means may be implemented in any suitable form. For example, the means may be implemented in a circuitry or software module. The first apparatus may be implemented as or included in the terminal device 610 in FIG. 6.

In some example embodiments, the first apparatus comprises means for determining a first switching time for the first apparatus to switch from reception on a first carrier to reception on a second carrier based on a first set of time parameters associated with frequency switching; means for determining a second switching time for the first apparatus to switch from reception on the second carrier to reception on the first carrier based on a second set of time parameters associated with frequency switching; and means for performing reception on the first and second carriers based on the first and second switching times.

In some example embodiments, the first carrier is configured for a transmission from the second apparatus to the first apparatus, and the second carrier is configured for a transmission from the first apparatus to the second apparatus and a transmission from the second apparatus to the first apparatus, and the first set of time parameters may comprise: a first retuning time for retuning a receiver from a first frequency of the first carrier to a second frequency of the second carrier, an activation time for activating a transmitter for a transmission from the first apparatus to the second apparatus, and a timing advance indicated by the second apparatus to the first apparatus, and wherein the second set of time may comprise a second retuning time for retuning the receiver from the second frequency of the second carrier to the first frequency of the first carrier.

In some example embodiments, the first apparatus may further comprise: means for receiving, from the second apparatus, configuration information comprising the timing advance.

In some example embodiments, the first apparatus may further comprise: means for transmitting, to the second apparatus, time information associated with carrier switching at the first apparatus.

In some example embodiments, the time information may comprise the first and second switching times.

In some example embodiments, the first switching time may be selected from a first set of switching times, and the second switching time may be selected from a second set of switching times.

In some example embodiments, the time information may comprise one or more time parameters associated with frequency switching at the first apparatus, and the one or more time parameters may be comprised in at least one of the first or second set of time parameters.

In some example embodiments, the one or more time parameters may comprise at least one of: a first retuning time for retuning a receiver from a first frequency of the first carrier to a second frequency of the second carrier, a second retuning time for retuning the receiver from the second frequency of the second carrier to the first frequency of the first carrier, or an activation time for activating a transmitter for a transmission from the first apparatus to the second apparatus.

In some example embodiments, the first apparatus may further comprise: means for switching from reception on the first carrier to reception on the second carrier by: means for retuning a receiver from a first frequency of the first carrier to a second frequency of the second carrier; means for activating a transmitter for a transmission from the first apparatus to the second apparatus; and means for performing a transmission to the second apparatus based on a timing advance indicated by the second apparatus to the first apparatus.

In some example embodiments, the first apparatus further comprises: means for switching from reception on the second carrier to reception on the first carrier by: means for retuning a receiver from a second frequency of the second carrier to a first frequency of the first carrier.

In some example embodiments, the first carrier may be a supplementary downlink, SDL, carrier and the second carrier may be a frequency division duplexing, FDD, carrier.

In some example embodiments, a second apparatus capable of performing any of the method 1300B (for example, the network device 620 in FIG. 6) may comprise means for performing the respective operations of the method 1300B. The means may be implemented in any suitable form. For example, the means may be implemented in a circuitry or software module. The second apparatus may be implemented as or included in the network device 620 in FIG. 6.

In some example embodiments, the second apparatus comprises means for receiving, from a first apparatus, time information associated with carrier switching at the first apparatus; means for determining, based on the received time information, a first switching time for switching from reception on a first carrier to reception on a second carrier and a second switching time for switching from reception on the second carrier to reception on the first carrier; and means for performing transmission on the first and second carriers based on the first and second switching times.

In some example embodiments, the time information may comprise the first and second switching times.

In some example embodiments, the first switching time may be selected from a first set of switching times, and the second switching time may be selected from a second set of switching times. The first and second sets of switching times may be predefined both at the terminal device 610 and the network device 620. If the network device 620 does not receive the signaling in which the terminal device 610 transmits the first and second switching times, the network device 620 may retrieve the default values of the first and second switching times from these predefined sets, respectively.

In some example embodiments, the second apparatus may further comprise: means for determining the first switching time based on a first set of time parameters comprising at least one of the one or more time parameters; and means for determining the second switching time based on a second set of time parameters comprising at least one of the one or more time parameters.

In some example embodiments, the one or more time parameters may comprise at least one of: a first retuning time for retuning a receiver from a first frequency of the first carrier to a second frequency of the second carrier, a second retuning time for retuning the receiver from the second frequency of the second carrier to the first frequency of the first carrier, or an activation time for activating a transmitter for a transmission from the first apparatus to the second apparatus.

In some example embodiments, the first carrier is configured for a transmission from the second apparatus to the first apparatus, and the second carrier is configured for a transmission from the first apparatus to the second apparatus and a transmission from the second apparatus to the first apparatus, the first set of time parameters may comprise: the first retuning time, the activation time, and a timing advance indicated by the second apparatus to the first apparatus, and the second set of time may comprise the second retuning time.

In some example embodiments, the first carrier may be a supplementary downlink, SDL, carrier and the second carrier may be a frequency division duplexing, FDD, carrier.

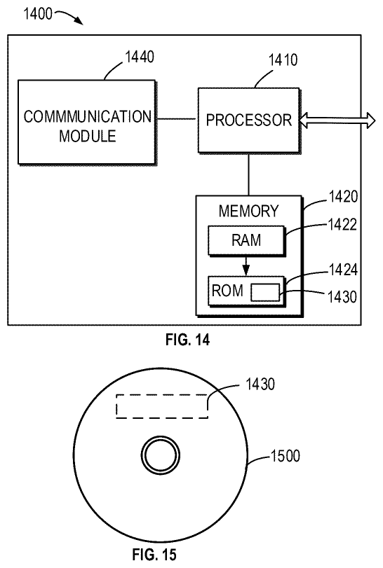

FIG. 14 is a simplified block diagram of a device 1400 that is suitable for implementing example embodiments of the present disclosure. The device 1400 may be provided to implement a communication device, for example, the terminal device 610 or the network device 620 as shown in FIG. 6. As shown, the device 1400 includes one or more processors 1410, one or more memories 1420 coupled to the processor 1410, and one or more communication modules 1440 coupled to the processor 1410.

The communication module 1440 is for bidirectional communications. The communication module 1440 has one or more communication interfaces to facilitate communication with one or more other modules or devices. The communication interfaces may represent any interface that is necessary for communication with other network elements. In some example embodiments, the communication module 1440 may include at least one antenna.

The processor 1410 may be of any type suitable to the local technical network and may include one or more of the following: general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

The memory 1420 may include one or more non-volatile memories and one or more volatile memories. Examples of the non-volatile memories include, but are not limited to, a Read Only Memory (ROM) 1424, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 1422 and other volatile memories that will not last in the power-down duration. A computer program 1430 includes computer executable instructions that are executed by the associated processor 1410. The instructions of the program 1430 may include instructions for performing operations/acts of some example embodiments of the present disclosure. The program 1430 may be stored in the memory, e.g., the ROM 1424. The processor 1410 may perform any suitable actions and processing by loading the program 1430 into the RAM 1422.

The example embodiments of the present disclosure may be implemented by means of the program 1430 so that the device 1400 may perform any process of the disclosure as discussed with reference to FIG. 7 to FIG. 11. The example embodiments of the present disclosure may also be implemented by hardware or by a combination of software and hardware.

In some example embodiments, the program 1430 may be tangibly contained in a computer readable medium which may be included in the device 1400 (such as in the memory 1420) or other storage devices that are accessible by the device 1400. The device 1400 may load the program 1430 from the computer readable medium to the RAM 1422 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 15 shows an example of the computer readable medium 1500 which may be in form of CD, DVD or other optical storage disk. The computer readable medium 1500 has the program 1430 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
determine a first switching time for the first apparatus to switch from reception on a first carrier to reception on a second carrier based on a first set of time parameters associated with frequency switching;
determine a second switching time for the first apparatus to switch from reception on the second carrier to reception on the first carrier based on a second set of time parameters associated with frequency switching; and
perform reception on the first and second carriers based on the first and second switching times.

2. The first apparatus of claim 1, wherein the first carrier is configured for a transmission from the second apparatus to the first apparatus, and the second carrier is configured for a transmission from the first apparatus to the second apparatus and a transmission from the second apparatus to the first apparatus, and the first set of time parameters comprises:
a first retuning time for retuning a receiver from a first frequency of the first carrier to a second frequency of the second carrier, and
a timing advance indicated by the second apparatus to the first apparatus,
and wherein the second set of time comprises a second retuning time for retuning the receiver from the second frequency of the second carrier to the first frequency of the first carrier.

3. The first apparatus of claim 2, wherein the first apparatus is further caused to:
receive, from the second apparatus, configuration information comprising the timing advance.

4. The first apparatus of claim 1, wherein the first apparatus is further caused to:
transmit, to the second apparatus, time information associated with carrier switching at the first apparatus.

5. The first apparatus of claim 4, wherein the time information comprises the first and second switching times.

6. The first apparatus of claim 5, wherein the first switching time is selected from a first set of switching times, and the second switching time is selected from a second set of switching times.

7. The first apparatus of claim 4, wherein the time information comprises one or more time parameters associated with frequency switching at the first apparatus, and the one or more time parameters are comprised in at least one of the first or second set of time parameters.

8. The first apparatus of claim 7, wherein the one or more time parameters comprise at least one of:
a first retuning time for retuning a receiver from a first frequency of the first carrier to a second frequency of the second carrier,
a second retuning time for retuning the receiver from the second frequency of the second carrier to the first frequency of the first carrier, or
an activation time for activating a transmitter for a transmission from the first apparatus to the second apparatus.

9. The first apparatus of claim 1, wherein the first apparatus is caused to:
switch from reception on the first carrier to reception on the second carrier by:
retuning a receiver from a first frequency of the first carrier to a second frequency of the second carrier;
activating a transmitter for a transmission from the first apparatus to the second apparatus; and
performing a transmission to the second apparatus based on a timing advance indicated by the second apparatus to the first apparatus.

10. The first apparatus of claim 1, wherein the first apparatus is caused to:
switch from reception on the second carrier to reception on the first carrier by:
retuning a receiver from a second frequency of the second carrier to a first frequency of the first carrier.

11. The first apparatus of claim 1, wherein the first carrier is a supplementary downlink, SDL, carrier and the second carrier is a frequency division duplexing, FDD, carrier.

12. A second apparatus comprising:
at least one processor; and
at least one memory storing instructions that, when executed by the at least one processor, cause the first apparatus at least to:
receive, from a first apparatus, time information associated with carrier switching at the first apparatus;
determine, based on the received time information, a first switching time for switching from reception on a first carrier to reception on a second carrier and a second switching time for switching from reception on the second carrier to reception on the first carrier; and
perform transmission on the first and second carriers based on the first and second switching times.

13. The second apparatus of claim 12, wherein the time information comprises the first and second switching times.

14. The second apparatus of claim 13, wherein the first switching time is selected from a first set of switching times, and the second switching time is selected from a second set of switching times.

15. The second apparatus of claim 12, wherein the time information comprises one or more time parameters associated with frequency switching at the first apparatus, and the second apparatus is caused to:
determine the first switching time based on a first set of time parameters comprising at least one of the one or more time parameters; and
determine the second switching time based on a second set of time parameters comprising at least one of the one or more time parameters.

16. The second apparatus of claim 15, wherein the one or more time parameters comprise at least one of:
a first retuning time for retuning a receiver from a first frequency of the first carrier to a second frequency of the second carrier,
a second retuning time for retuning the receiver from the second frequency of the second carrier to the first frequency of the first carrier, or
an activation time for activating a transmitter for a transmission from the first apparatus to the second apparatus.

17. A method comprising:
determining a first switching time for the first apparatus to switch from reception on a first carrier to reception on a second carrier based on a first set of time parameters associated with frequency switching;
determining a second switching time for the first apparatus to switch from reception on the second carrier to reception on the first carrier based on a second set of time parameters associated with frequency switching; and
performing reception on the first and second carriers based on the first and second switching times.

18. The method of claim 17, wherein the first carrier is configured for a transmission from the second apparatus to the first apparatus, and the second carrier is configured for a transmission from the first apparatus to the second apparatus and a transmission from the second apparatus to the first apparatus, and the first set of time parameters comprises:
a first retuning time for retuning a receiver from a first frequency of the first carrier to a second frequency of the second carrier, and
a timing advance indicated by the second apparatus to the first apparatus,
and wherein the second set of time comprises a second retuning time for retuning the receiver from the second frequency of the second carrier to the first frequency of the first carrier.

19. The method of claim 18, further comprising:
receive, from the second apparatus, configuration information comprising the timing advance.

20. The method of claim 17, further comprising:
transmit, to the second apparatus, time information associated with carrier switching at the first apparatus.
